(19) United States
(12) Patent Application Publication
(10) Pub. No.: US 2014/0330786 A1
(43) Pub. Date: Nov. 6, 2014

(54) COMPUTER-IMPLEMENTED METHODS AND SYSTEMS FOR REVISION CONTROL OF INTEGRATED CIRCUIT LAYOUT RECIPE FILES

(71) Applicant: GLOBAL FOUNDRIES, INC., Grand Cayman (KY)

(72) Inventors: Elizabeth John, Milpitas, CA (US); Nanshu Chen, Sunnyvale, CA (US)

(73) Assignee: GLOBAL FOUNDRIES, INC., Grand Cayman (KY)

(21) Appl. No.: 13/875,942

(22) Filed: May 2, 2013

(51) Int. Cl. G06F 17/30

(52) U.S. Cl. CPC G06F 17/30088
USPC 707/649

(57) ABSTRACT

Computer-implemented methods and systems for providing revision control of integrated circuit device layout recipe files are provided. In an exemplary embodiment, a computer-implemented method for providing revision control of integrated circuit device layout recipe files includes storing recipe configuration files and recipe library files. Further, the method provides a user access to the recipe configuration files and recipe library files. The method includes creating with a computer a version snapshot of a selected recipe configuration file as revised by the user and of the other recipe configuration files and recipe library files as existing when the selected recipe configuration file is opened by the user. Further, the method includes providing the user access to all version snapshots for optical proximity correction (OPC) simulation.

### TECHNICAL FIELD

The technical field generally relates to integrated circuit device design and manufacture, and more particularly relates to a computer-implemented method and system for providing revision control of integrated circuit layout recipe files.

### BACKGROUND

When designing an integrated circuit (IC) device, engineers or designers typically rely on computer design tools to help create an IC schematic or design, which can include a multitude of individual devices, such as transistors, coupled together to perform a certain function. To actually fabricate the IC device in or on a semiconductor substrate, the IC device schematic must be translated into a physical representation or layout, which itself can be transferred onto the surface of the semiconductor substrate. Computer-aided design (CAD) tools can be used to assist layout designers with translating the discrete circuit elements into shapes, which will embody the devices themselves in the completed IC device. These shapes make up the individual components of the circuit, such as gate electrodes, diffusion regions, metal interconnects and the like.

Software programs employed by the CAD systems to produce layout representations are typically structured to function under a set of predetermined design rules in order to produce a functional circuit. Often, the design rules are determined by certain processing and design limitations based roughly on the patternability of layout designs. For example, design rules may define the space tolerance between devices or interconnect lines. Typically, the formation of IC devices on a wafer relies on lithographic processes, sometimes referred to as photolithography, or simply lithography. As is well known, lithographic processes can be used to transfer a pattern of a photomask (also referred to as a mask or a reticle) to a wafer. For instance, patterns can be formed from a photoresist layer disposed on the wafer by passing light energy through a mask having an arrangement to image the desired pattern onto the photoresist layer.

There is a pervasive trend in the field of IC fabrication to increase the density with which various structures are arranged. For example, feature size, line width, and the separation between features and lines are becoming increasingly smaller. Yield of IC fabrication processes is affected by factors such as mask pattern fidelity, optical proximity effects and photoresist processing. Optical proximity correction (OPC) has been used to improve image fidelity. In general, current OPC techniques involve conducting computer simulations that take initial data sets having information relating the desired patterns and manipulate the data sets to arrive at corrected data sets in an attempt to compensate for the above-mentioned concerns. The photomask can then be made in accordance with the corrected data set. Briefly, the OPC process can be governed by a set of geometrical rules (e.g., “rule-based OPC” employing fixed rules for geometric manipulation of the data set), a set of modeling principles (e.g., “model-based OPC” employing predetermined behavior data to drive geometric manipulation of the data set) or a hybrid combination of rule-based OPC and model-based OPC.

Algorithms to perform OPC are maintained in files for each layer in the IC device and are called recipes or keywords. When OPC is conducted, an OPC data file or pattern is generated from each recipe, and more specifically, from the configuration files, such as extensible markup language (XML) files, and associated library files that form each recipe. During creation or enhancement of a recipe, configuration files and library files may be revised hundreds of times. Further, each file revision may have an effect on the resulting OPC pattern or data file. Because of the large number of configuration files, library files, and other components involved during an OPC simulation, subtle changes in associated files caused by revising selected configuration files or library files can go unnoticed. Also, these changes can cause system OPC problems that might not be noticed immediately. Keeping track of multiple revisions to the configuration files and associated library files is challenging.

Accordingly, it is desirable to provide an improved computer-implemented method and system for providing revision control of integrated circuit device layout recipe files. In addition, it is desirable to provide computer-implemented methods and systems that provide for comprehensive OPC testing of multiple versions of integrated circuit layouts. Furthermore, other desirable features and characteristics will become apparent from the subsequent detailed description and the appended claims, taken in conjunction with the accompanying drawings and the foregoing technical field and background.

### BRIEF SUMMARY

Computer-implemented methods and systems for providing revision control of integrated circuit device layout recipe files are provided. In one exemplary embodiment, a computer-implemented method for providing revision control of integrated circuit device layout recipe files includes storing recipe configuration files and recipe library files. Further, the method provides a user access to the recipe configuration files and recipe library files. The method includes creating with a computer a version snapshot of a selected recipe configuration file as revised by the user and of the other recipe configuration files and recipe library files as existing when the selected recipe configuration file is opened by the user. Further, the method includes providing the user access to all version snapshots for optical proximity correction (OPC) simulation.

In accordance with another embodiment, a computer-implemented method is provided for testing integrated circuit layouts. The computer-implemented method for testing integrated circuit layouts includes creating with a computer a version snapshot of recipe configuration files and recipe library files forming a recipe for an integrated circuit layout when any recipe configuration file or recipe library file is developed or revised. The method stores the version snapshots in a file version database. Further, the method includes conducting an optical proximity correction on selected version snapshots and creating a resulting simulated pattern file for each selected version snapshot.

In another embodiment, a system for providing revision control of integrated circuit device layout recipe files includes a central file repository configured to store recipe configuration files and recipe library files. The system further includes a local repository in communication with the central file repository and configured to provide a user access to the recipe configuration files and recipe library files. Also, a local repository manager is in communication with the local repository and is configured to create a version snapshot of a selected recipe configuration file as revised by the user and of the other recipe configuration files and recipe library files. The system includes a file version database in communication with the local repository manager for storing each version snapshot. Also, the system includes a layout date file repository for storing layout data files created by an optical proximity correction (OPC) simulation of a recipe defined by recipe configuration files and recipe library files in a selected version snapshot.

### BRIEF DESCRIPTION OF THE DRAWINGS

Embodiments of computer-implemented methods and systems for providing revision control of integrated circuit device layout recipe files will be described in conjunction with the following drawing figures, wherein like numerals denote like elements, and wherein:

FIG. 1 is a production flow diagram of an exemplary process for producing an IC device;

FIG. 2 is a schematic block diagram of an exemplary process of the wafer patterning step for producing an IC device;

FIG. 3 is a schematic block diagram of a computer system capable of developing and editing an integrated circuit device layout recipe and of executing an optical proximity correction (OPC) simulation from the integrated circuit device layout recipe;

FIG. 4 is a schematic block diagram of a system providing revision control of the integrated circuit device layout recipe developed by the computer system of FIG. 2; and

FIG. 5 is a flow diagram for providing revision control with the system of FIG. 3.

### DETAILED DESCRIPTION

The following detailed description is merely exemplary in nature and is not intended to limit the computer-implemented methods and systems for providing revision control of integrated circuit device layout recipe files claimed herein. Furthermore, there is no intention to be bound by any expressed or implied theory presented in the preceding technical field, background or brief summary, or in the following detailed description.

The computer-implemented methods and systems for providing revision control of integrated circuit device layout recipe files enhance development, revision, and testing of integrated circuit device layout recipe files. For example, the methods and systems described herein provide for storing a comprehensive history of all revisions to files in a recipe integrated circuit device layout recipe. Rather than saving only revised files at the time of revision, the methods and systems described herein save “version snapshots” of all associated recipe files when any one recipe file is developed or revised. Therefore, a developer may “go back in time” to see the state of all files when analyzing a selected revision. This ability reduces development and revision time, as developers need not re-create old versions of later-changed files to view a previous stage of recipe development. Also, the method and system described herein provide for robust testing of recipe files from different selected version snapshots to evaluate the source of features, bugs or other issues in a recipe under development.

Embodiments herein will be described in the exemplary context of the preparation process for ultimately patterning a layer of material (e.g., a polysilicon gate or word line layer, a dielectric layer, a source/drain layer, a metal interconnect layer, a contact layer, etc.) that forms a part of an integrated circuit. Example integrated circuits include general use processors made from thousands or millions of transistors, a flash memory array or any other dedicated circuitry. However, one skilled in the art will appreciate that the methods and systems described herein can also be applied to the process of manufacturing any article made using photolithography, such as micromachines, disk drive heads, gene chips, micro electromechanical systems (MEMS) and so forth.

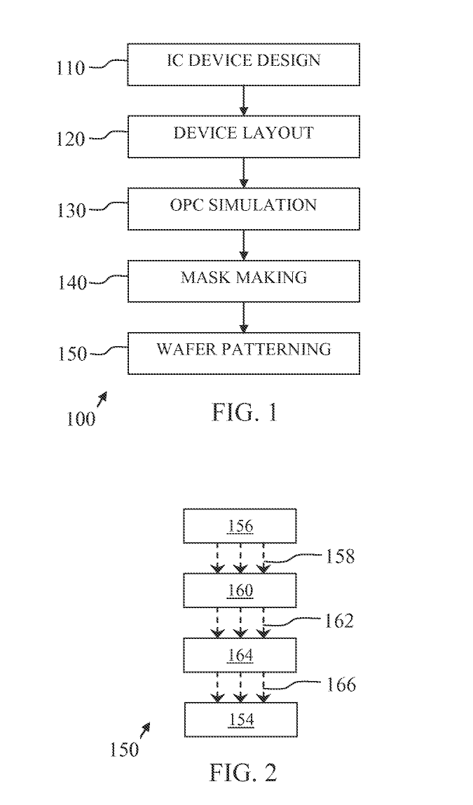

FIG. 1 illustrates an exemplary production method 100 for producing an IC device. The general production method 100 depicted in FIG. 1 is relatively well-known and, therefore, will not be described in great detail. Step 110 includes receiving, providing or otherwise generating an IC device design, which can be embodied in a high-level “netlist” description. At step 120, the device design can be converted or otherwise translated into a physical representation or layout. At step 130, optical proximity correction (OPC) and simulation can be performed on the device layout to improve image fidelity. At step 140, the layout data can be converted to or otherwise represented as reticle data for use in mask making Once the appropriate mask is made at step 140, the wafer can be patterned at step 150 (including many repeated patterning, etching, deposition and polishing steps), thereby providing a manufactured IC device.

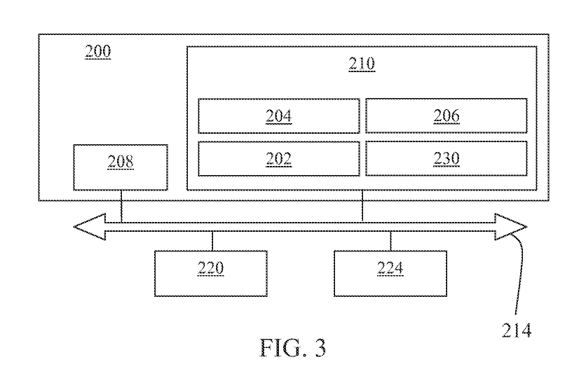

As shown in FIG. 2, the wafer patterning process step 150 utilizes a lithography system 152 used to image a pattern onto a wafer 154, or a region thereof. The system 152 can be, for example, a step-and-repeat exposure system or a step-and-scan exposure system, but is not limited to these example systems. The system 152 can include a radiation (e.g., light) source 156 for directing energy, indicated by arrows 158, toward a photomask 160. The energy 158 can have, for example, a deep ultraviolet wavelength, or a vacuum ultraviolet (VUV) wavelength, although other wavelengths, including extreme ultraviolet wavelengths, are possible.

The photomask 160 selectively blocks (or, in some instances, selectively reflects or phase shifts) light energy 158 such that a light energy pattern, indicated by arrows 162, defined by the photomask 160 is transferred towards the wafer 154. An imaging subsystem 164, such as a stepper assembly or a scanner assembly, sequentially directs the energy pattern 162 transmitted by the photomask 160 to a series of desired locations on the wafer 154. The imaging subsystem 164 may include a series of lenses and/or reflectors for use in scaling and directing the energy pattern 162 toward the wafer 154 in the form of an imaging (or exposure) energy pattern, indicated by arrows 166.

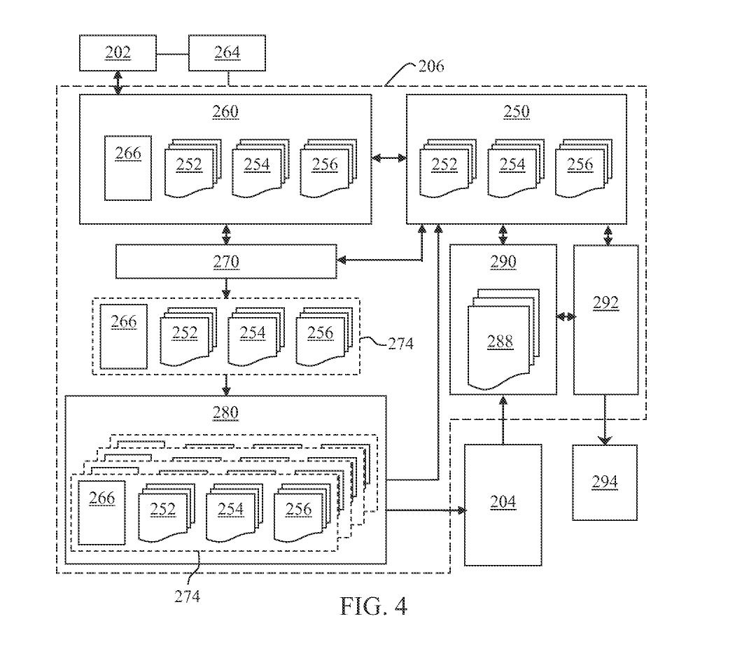

Turning now to FIG. 3, a schematic block diagram of a computer system 200 capable of creating and editing recipe files and of executing an optical correction proximity OPC simulation based on recipe files during step 120 of FIG. 1 and in accordance with embodiment herein is illustrated. As shown, the computer system 200 includes a recipe creation/editing tool (hereafter “recipe tool”) 202 and an OPC simulation tool 204. Further, the computer system 200 includes a versioning or revision control system 206 in communication with the recipe tool 202 for managing versioned or revised recipe files created using the recipe tool 202. Alternatively, recipe creation/editing, revision control and OPC can be carried out by different computer systems that are optionally networked together. In one embodiment, the recipe tool 202, OPC simulation tool 204 and revision control system 206 are embodied as one or more computer programs (e.g., one or more software applications including compilations of executable code). The computer program(s) can be embodied on a computer readable medium, such as a magnetic or optical storage device.

To execute the recipe tool 202, the OPC simulation tool 204 and/or the revision control system 206, the computer system 200 can include one or more processors 208 used to execute instructions that carry out a specified logic routine. In addition, the computer system 200 can have a memory 210 for storing data, software, logic routine instructions, computer programs, files, operating system instructions, and the like. The memory 210 can comprise several devices and includes, for example, volatile and non-volatile memory components. As used herein, the memory 210 can include, for example, random access memory (RAM), read-only memory (ROM), disks, tapes, and/or other memory components, plus associated drives and players for these memory types. The processor 208 and the memory 210 are coupled using a local interface 214. The local interface 214 can be, for example, a data bus with accompanying control bus, a network, or other subsystem.

The computer system 200 can have various video and input/output interfaces 220 as well as one or more communications interfaces 224. The interfaces 220 can be used to couple the computer system 200 to various peripherals and networked devices, such as a display (e.g., a CRT display or LCD display), a keyboard, a mouse, a microphone, a camera, a scanner, a printer, a speaker and so forth. The interfaces 224 can be comprised of, for example, a modem and/or network interface card, and can enable the computer system 200 to send and receive data signals, voice signals, video signals, and the like via an external network, such as the internet, a wide area network (WAN), a local area network (LAN), direct data link, or similar wired or wireless system.

The memory 210 stores an operating system 230 that is executed by the processor 208 to control the allocation and usage of resources in the computer system 200. Specifically, the operating system 230 controls the allocation and usage of the memory 210, the processing time of the processor 208 dedicated to various applications being executed by the processor 208, and the peripheral devices, as well as performing other functionality. In this manner, the operating system 230 serves as the foundation on which applications, such as the recipe tool 202 and OPC simulation tool 204, depend as is generally known by those with ordinary skill in the art. While the computer system 200 is shown to include the recipe tool 202 and OPC simulation tool 204, other tools such as fragmentation tools, may be included in the computer system 200.

FIG. 4 illustrates the versioning or revision control system 206 for managing versioned or revised files created with recipe tool 202 of FIG. 3 in accordance with embodiments herein. As shown, the revision control system 206 includes a central file repository 250 that may be stored in memory 210 of FIG. 3. Central file repository 250 holds recipe files that are necessary for the creation or editing of recipes for IC layouts. Specifically, the central file repository 302 may hold recipe configuration files 252, recipe library files 254, and other recipe files or data 256 needed to create IC layout data files to make photomasks for IC fabrication.

As shown, the revision control system 206 includes or provides a local repository or sandbox 260 in communication with the central file repository 250 for access by a user 264. The user 264 may access the central file repository 250 in the revision control system 206 directly, or through the recipe tool 202. The user 264 may request access to a selected file 266 from the recipe files 252, 254, and 256 in the central file repository 250. In response to a user request, the central file repository 250 transfers a copy of the selected recipe file to the local repository 260. The revision control system 206 further includes a local repository manager 270 that controls or manages the recipe files 252, 254, 256 received in the local repository 260. Specifically, when a revision is made to the selected recipe file in the local repository 260 by the user 264, the local repository manager 270 creates a version snapshot 274 of the selected recipe file as revised and of recipe configuration files 252, recipe library files 254, or other recipe files 256 associated with the selected recipe file, e.g., files that pertain to the same layer in the IC device. The version snapshot 274 thus contains all of the data pertinent to the revision performed on the selected recipe file at the time of the revision. In an exemplary embodiment, the version snapshot 274 is saved with a unique primary key, such as a time-date stamp and/or information relating to the selected file or the revision. Further, an exemplary version snapshot 274 includes a top-level configuration file with metadata of all states of the recipe configuration files 252 and recipe library files 254 in the user's local repository 260 at the time of creating the version snapshot 274.

The revision control system 206 provides for storing each snapshot 274 when created in a file version database 280 which may be maintained in the memory 210 shown in FIG. 3. Further, the file version database 280 may be stored in or available to the central file repository 250. The file version database 280 includes a full history of the state of all files 252, 254, and 256 (including selected files 266) as selected files 266 are revised during creation and editing of the recipe. Therefore, the user 264 may access and compare the state of recipe files 252, 254, and 256 at selected times for analysis, for example to determine when a feature or bug is introduced to the recipe.

In FIG. 4, the file version database 280 is in communication with the OPC simulation tool 204. The user 264 may select a version snapshot 274 and request OPC simulation by the OPC simulation tool 204. As a result, the OPC simulation tool 204 conducts an OPC simulation using the recipe files 252, 254 and 256 in the selected snapshot 274. The OPC simulation results in creation of a simulated pattern file or layout data file 288 that is unique to the recipes files 252, 254 and 256 from the selected snapshot 274. The layout data file 288 is typically a binary file format representing planar geometric shapes, text labels, and other information about the layout in hierarchical form. For example, the layout data file 288 may be in graphic database system (GDSII) stream format or OASIS format, both of which are database file formats for data exchange of integrated circuit or IC layout artwork. The data in the layout data file 288 can be used to reconstruct all or part of the artwork to be used in sharing layouts, transferring artwork between different tools, or creating photomasks.

As shown, each layout data file 288 is saved in a layout data file repository 290. The layout data file repository 290 may be maintained in the memory 210 shown in FIG. 3. The exemplary revision control system 206 further includes a regression manager 292 in communication with layout data file repository 290 to manage OPC simulation results. In an embodiment, the regression manager 292 may be maintained as part of the OPC simulation tool 204. Alternatively, the regression manager 292 may communicate directly with the OPC simulation tool 204.

When evaluation of various revisions to recipe files 252, 254 and 256 is desired, the user 264 may select the relevant version snapshots 274 for simulation by the OPC simulation tool 204. If simulations already have been performed on a selected snapshot or selected snapshots, the revision manager 292 may provide the relevant layout data file(s) 288 for selection by the user 264 from the layout repository 290. Further, the regression manager 292 may test or analyze the relevant data file(s) to identify when and what revisions were made, and what effect the revisions had on the layout data file(s) 288. The regression manager 292 may provide such analysis to the user 264 in the form of a test report 294.

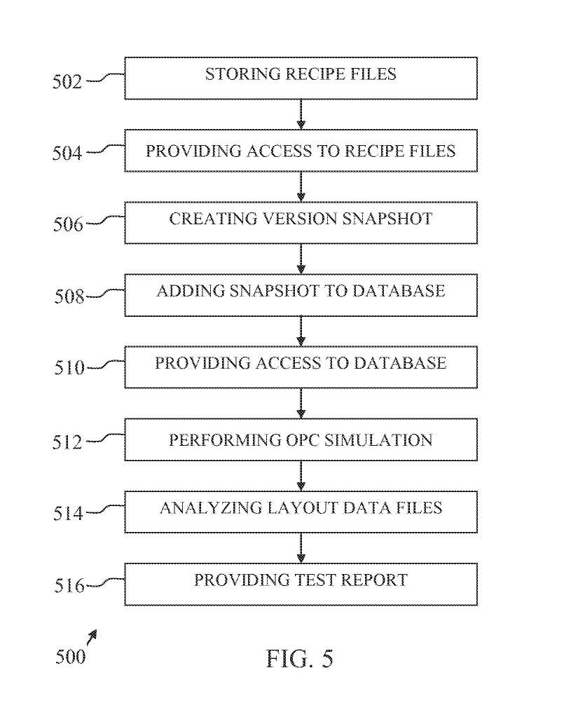

FIG. 5 provides a flow chart illustrating a computer-implemented method 500 for providing revision control of recipe files for generation and analysis of integrated circuit device layouts. As shown, the method 500 includes a step 502 of storing recipe configuration files 252 and recipe library files 254 in the central recipe file repository 250. Further, the method 500 includes a step 504 of providing the user 264 access to the recipe configuration files 252 and recipe library files 254. Performance of step 504 may include transferring the recipe configuration files 252 and recipe library files 254 from the central file repository 250 to the user's local repository 260.

Upon revision of a selected file 266, step 506 of the method 500 creates a version snapshot 274 of a selected file 266 as revised by the user and of the other recipe configuration files 252 and recipe library files 254 as existing in the local repository 260. The version snapshot 274 may be saved with a unique primary key, such as a time-date stamp and/or information relating to the selected file or the revision. In an exemplary embodiment, the version snapshot 274 includes a top-level configuration file with metadata of all states of the recipe configuration files 252 and recipe library files 254 in the user's local repository 260 at the time of creating the version snapshot 274. The exemplary revision control system 206 provides for regenerating the configuration files and the library files in a selected version snapshot from the corresponding top-level configuration file.

As shown, the method 500 further includes adding the version snapshot 274 to the file version database 280 at step 508. Steps 502 through 508 may be repeated hundreds of times as recipe files are created and revised. As a result, the file version database 280 may include hundreds of version snapshots 274. The method 500 further includes step 510 which provides the user 264 access to all version snapshots 274 in the file version database 280 for optical proximity correction (OPC) simulation. In an exemplary embodiment, step 510 includes providing access to top-level configuration files. Upon selection of a top-level configuration file, step 510 include regenerating the recipe configuration files 252 and the recipe library files 254 in the selected version snapshot 274 from the corresponding top-level configuration file.

Method 500 continues with step 512 in which, in response to a request by the user, OPC simulations are performed on the recipe files in selected version snapshots 274. Step 512 creates a resulting simulated pattern file or layout data file 288 for each selected version snapshot 274. For regression analysis, step 514 of the method analyzes and/or compares layout data files 288 for selected version snapshots 274. Step 514 may be performed in direct response to a user 264 direction and selection of version snapshots 274 for analysis. As shown, step 516 includes providing test reports including the analysis or comparison of selected version snapshots 274 to the user 264. Such test reports may be utilized by the user 264 to identify the source or errors, features, or other characteristics in the recipe files during creation or editing of a recipe.

As described, the revision control system 206 and method 500 allow a user to compare versions of a recipe, including recipe configuration files and recipe library files, from different stages of development or revision. Further, while a single recipe file may be revised at a given time, the revision control system 206 and method 500 provide the user access to all relevant recipe files at the time of revision, i.e., access is not limited to the revised file. Therefore, the user is provided with the ability to analyze and compare selected versions or the state of the recipe at all stages of development and revision. This ability eliminates the need for the user to recreate files to match erased or written over files.

While at least one exemplary embodiment has been presented in the foregoing detailed description, it should be appreciated that a vast number of variations exist. It should also be appreciated that the exemplary embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application.

What is claimed is:

1. A computer-implemented method for providing revision control of integrated circuit device layout recipe files, the computer-implemented method comprising:
storing recipe configuration files and recipe library files;
providing a user access to the recipe configuration files and recipe library files;
creating with a computer a version snapshot of a selected recipe configuration file as revised by the user and of other recipe configuration files and recipe library files as existing when the user accessed the recipe configuration files and recipe library files; and
providing the user access to all version snapshots for optical proximity correction (OPC) simulation.

2. The computer-implemented method of claim 1 wherein storing recipe configuration files and recipe library files comprises storing recipe configuration files and recipe library files in a central recipe file repository.

3. The computer-implemented method of claim 2 wherein providing a user access to the recipe configuration files and recipe library files comprises transferring the recipe configuration files and recipe library files from the central recipe file repository to a user's local repository.

4. The computer-implemented method of claim 3 further comprising adding the version snapshot to a file version database.

5. The computer-implemented method of claim 3 further comprising adding the version snapshot to a file version database, and wherein providing the user access to all version snapshots for optical proximity correction (OPC) simulation comprises providing the user access to all version snapshots in the file version database for optical proximity correction (OPC) simulation.

6. The computer-implemented method of claim 1 wherein creating with a computer a version snapshot comprises saving the version snapshot with a unique primary key.

7. The computer-implemented method of claim 1 further comprising performing OPC simulations on selected version snapshots and creating a resulting simulated pattern file for each selected version snapshot.

8. The computer-implements method of claim 1 wherein providing a user access to the recipe configuration files and recipe library files comprises transferring the recipe configuration files and recipe library files to a user's local repository; and wherein creating with a computer a version snapshot comprises saving a top-level configuration file including metadata of all states of the recipe configuration files and recipe library files currently in the user's local repository.

9. The computer-implemented method of claim 8 wherein providing the user access to all version snapshots for optical proximity correction (OPC) simulation comprises providing access to each top-level configuration file, and wherein the computer-implemented method further comprises regenerating the recipe configuration files and the recipe library files in a selected version snapshot from a selected top-level configuration file.

10. A computer-implemented method for testing integrated circuit layouts, the computer-implemented method comprising:
creating with a computer a version snapshot of recipe configuration files and recipe library files forming a recipe for an integrated circuit layout when any recipe configuration file or recipe library file is developed or revised;
storing each version snapshot in a file version database; and
conducting an optical proximity correction (OPC) simulation on selected version snapshots and creating a resulting simulated pattern file for each selected version snapshot.

11. The computer-implemented method of claim 10 further comprising:
providing a user access to each snapshot including recipe configuration files and recipe library files for revision of a selected recipe configuration file or a selected recipe library file.

12. The computer-implemented method of claim 11 wherein providing a user access to each version snapshot including recipe configuration files and recipe library files for revision of a selected recipe configuration file or a selected recipe library file comprises transferring a selected version snapshot to a user's local repository.

13. The computer-implemented method of claim 10 further comprising providing a user access to all version snapshots in the file version database for selection for OPC simulation.

14. The computer-implemented method of claim 10 wherein creating with a computer a version snapshot of recipe configuration files and recipe library files forming a recipe for an integrated circuit layout when any recipe configuration file or recipe library file is developed or revised comprises creating a version snapshot with a unique primary key.

15. The computer-implemented method of claim 10 wherein creating with a computer a version snapshot of recipe configuration files and recipe library files forming a recipe for an integrated circuit layout when any recipe configuration file or recipe library file is developed or revised comprises creating a top-level configuration file including metadata of all states of associated recipe configuration files and recipe library files.

16. The computer-implemented method of claim 10 further comprising providing a user access to each snapshot including recipe configuration files and recipe library files for revision of a selected recipe configuration file or a selected recipe library file by transferring the recipe configuration files and recipe library files to a user's local repository, and wherein creating with a computer a version snapshot comprises saving a top-level configuration file including metadata of all states of the recipe configuration files and recipe library files currently in the user's local repository.

17. The computer-implemented method of claim 10 further comprising comparing resulting simulated pattern files to identify when a feature is introduced to the recipe configuration files or the recipe library files.

18. The computer-implemented method of claim 10 further comprising preparing a report including a comparison of resulting simulated pattern files.

19. A system for providing revision control of integrated circuit device layout recipe files, the system comprising:
a central file repository configured to store recipe configuration files and recipe library files;
a local repository in communication with the central file repository and configured to provide a user access to the recipe configuration files and recipe library files;
a local repository manager in communication with the local repository and configured to create a version snapshot of a selected recipe configuration file as revised by the user and of other recipe configuration files and recipe library files;
a file version database in communication with the local repository manager for storing each version snapshot; and
a layout date file repository for storing layout data files created by an optical proximity correction (OPC) simulation of a recipe defined by recipe configuration files and recipe library files in a selected version snapshot.

20. The system of claim 19 further comprising a regression manager configured to compare selected layout data files.
